(19) United States
(12) Patent Application Publication
(10) Pub. No.: US 2004/0210521 A1
(43) Pub. Date: Oct. 21, 2004

(54) Web-based payment system with consumer interface and methods

(75) Inventors: Kim Crea, Lone Tree, CO (US); Jennifer Grimes, Parker, CO (US); Marilyn Bethke, Greenwood Village, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/406,793

(22) Filed: Apr. 2, 2003

(51) Int. Cl. G06F 17/60

(52) U.S. Cl. 705/40; 705/39

(57) ABSTRACT

A method of processing a payment from a payer to a payee includes receiving at a host computer system a request to initiate a payment and transmitting from the host computer system to a payer computer a file comprising a display screen configured for receiving, from the payer, information relating to the payment. The method also includes receiving the information from the payer at the host computer system. The method also includes creating with the host computer system a credit transaction based on the information that debits funds from a transaction processor's bank and credits funds to a bank of the payee and creating with the host computer system a debit transaction based on the information that debits funds from a bank of the payer and credits funds to the transaction processor's bank. The method also includes sending both the debit transaction and the credit transaction to a banking network within one banking day.

### CROSS-REFERENCES TO RELATED APPLICATIONS

This application is related to U.S. patent application Ser. No. 10/267,150, entitled “WEB-BASED PAYMENT SYSTEM AND METHOD” (Attorney Docket No. 020375-007510), filed on Oct. 8, 2002, by Patricia A. Frazier and David T. Shapiro, which is a non-provisional of and claims priority to Provisional U.S. Patent Application No. 60/339,732, entitled, “WEB-BASED PAYMENT SYSTEM AND METHOD” (Attorney Docket No. 020375-007500US), filed on Dec. 10, 2001, by Patricia A. Frazier, David T. Shapiro, and Marilyn J. Bethke, which applications are incorporated herein in their entirety for all purposes.

### BACKGROUND OF THE INVENTION

The present invention relates to network-based payment processing. More particularly, the present invention relates to the processing of payments from a consumer to a payee using a network-based consumer interface.

Many consumers now transact with merchants and other businesses or service providers on-line, either through the Internet or other network. Such networks provide convenient means for consumers to order services, view account activity, make payments, and the like. Some systems even allow consumers to pay merchants from directly from their checking accounts by entering bank account information into display screens. The information is then processed through a banking network, such as the Automated Clearing House (ACH) network. Such systems are limited, however, because the consumer's account is not credited with having satisfied the obligation until the funds are received at the payee's bank. Thus, improved systems are needed that more quickly credit consumers with having satisfied an obligation owed to a payee.

### BRIEF SUMMARY OF THE INVENTION

Embodiments of the present invention thus provide a method of processing a payment from a payer to a payee. The method includes receiving at a host computer system a request to initiate a payment and transmitting from the host computer system to a payer computer a file comprising a display screen configured for receiving, from the payer, information relating to the payment. the method also includes receiving the information from the payer at the host computer system and creating with the host computer system a credit transaction based on the information that debits funds from a transaction processor's bank and credits funds to a bank of the payee. The method further includes creating with the host computer system a debit transaction based on the information that debits funds from a bank of the payer and credits funds to the transaction processor's bank. The method also includes sending both the debit transaction and the credit transaction to a banking network within one banking day. In some embodiments the banking network comprises the Automated Clearing House (ACH) network. The method may include receiving funds at the payee's bank within one banking day of receiving the information from the payer. The method also may include creating with the host computer system a posting statement based on the information and sending the posting statement to a payee computing system. In still other embodiments, the method may include calculating a fee relating to the payment and transmitting a file to the payer computer that includes a display screen that displays the fee to the payer. In still other embodiments, the method may include receiving a request from the payer to abort the transaction and aborting the transaction. The method also may include receiving a notification that the bank of the payer has rejected the transaction, creating a reversal transaction that withdraws funds from the bank of the payee, and sending the debit transaction to the banking network. The method further may include receiving information from other payers similar to the information from the payer and using the notification and the similar information to prepare a debit transaction and a credit transaction. The method may include consolidating the information from the payer with similar information from other payers and using the consolidated information to prepare a debit transaction and a credit transaction.

In other embodiments, a payee computer system includes means for interacting, via a network, with a payer and means for receiving from the payer a request to make a payment to the payee. The payee computer system also may include means for linking the payer to a transaction processor's computer system that is programmed to present a series of payment information receiving screens having branding information relating to the payee. The system may include means for transferring information relating to the payer to the transaction processor's computer system.

In still other embodiments of the invention, a method of receiving payment information from a payer includes interacting, via a network, with the payer, receiving from the payer a request to make a payment to the payee, linking the payer to a transaction processor's computer system that is programmed to present a series of payment information receiving screens having branding information relating to the payee.

In another embodiment of the invention, a system for processing a payment from a payer to a payee includes a host computer system that includes an interface to a payer computer, an interface to a banking network, and an interface to a payee computing system. The host computer system is programmed to receive through the interface to the payer computer a request from the payer to initiate a payment, transmit from the host computer system to the payer computer through the interface to the payer computer a file comprising a display screen configured for receiving information relating to the payment from the payer, receive the information from the payer computer through the interface to the payer computer, create a credit transaction that debits funds from a transaction processor's bank and credits funds to a bank of the payee, create a debit transaction based on the information that debits funds from a bank of the payer and credits funds to the transaction processor's bank, and send both the debit transaction and the credit transaction to the banking network through the interface to the banking network on a banking day.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 illustrates a system for processing payments from a consumer to a payee according to embodiments of the present invention.

FIG. 2 illustrates a payment display screen according to one example of the present invention.

FIG. 3 illustrates a bank information display screen according to one example of the present invention.

FIG. 4 illustrates a payment confirmation display screen according to one example of the present invention.

FIGS. 5A and B illustrates a terms and conditions display screen according to one example of the present invention.

FIG. 6 illustrates a final confirmation display screen according to one example of the present invention.

FIG. 7 depicts a flow diagram of a method for processing payments that may be implemented in the system of FIG. 1.

### DETAILED DESCRIPTION OF THE INVENTION

The present invention relates to systems and methods for facilitating the payment of obligations by consumers. According to the present invention, a consumer accesses a web site operated by or on behalf of a payee to whom the consumer owes money. The consumer expresses an intention to pay at least a portion of the obligation owed to the payee. The consumer is presented with a payment screen having blanks for the consumer to complete that provide information necessary to complete the payment from the consumer to the payee. Such information may include the consumer's account number with the payee, the consumer's bank account number, the bank's ABA routing number, and the like. Appropriate security screens may be used to insure the consumer's account information remains private.

Once the consumer supplies the information, it is used to initiate the appropriate transactions through the ACH or other banking network. In a specific embodiment, the information is sent to a transaction processor. The transaction processor processes a debit transaction through the ACH network that withdraws funds from the consumer's bank account. The transaction processor also processes a credit transaction through the ACH network that deposits funds into the payee's bank account. In some embodiments, the transaction processor also sends posting information to the payee's accounting system that reflects the payment from the consumer to the payee.

In some embodiments of the present invention, the same transaction is used to withdraw funds from the consumer's bank and deposit the funds into the payee's bank. In other embodiments, however, the debit transaction results in a transfer of funds from the consumer's bank account to the transaction processor's bank account, and the credit transaction results in a transfer of funds from the transaction processor's bank account to the payee's bank account. The transaction processor may initiate the credit transaction contemporaneously with the debit transaction, for example in the same banking day or within one banking day. Because the processing of the transactions through the ACH network takes time, the transaction processor may have funds withdrawn from its bank account to pay the payee before the transaction processor receives funds from the consumer.

In some instances, the debit transaction cannot be completed. For example, the consumer may not have sufficient funds to complete the payment, the consumer may have initiated a “stop payment” relating to the transaction, or the like. In such cases, the transaction processor may initiate another transaction that removes funds previously credited to the payee's bank account. The transaction processor also may send posting information to the payee's accounting system to reflect the reversal of the transaction.

In some embodiments, the transaction processor consolidates a number of transactions with the payee's bank into a single transaction. For example, if the transaction processor initiates three deposits crediting a total of $1200 to the payee's bank and also initiates a $200 withdrawal from the payee's bank, the transaction processor may combine the transactions into a single deposit of $1000 from the transaction processor's bank to the payee's bank. The transaction processor also may consolidate multiple transactions with a consumer's bank.

The present invention provides the ability for a consumer to complete a payment to a payee in a short period of time. For example, the consumer may be able to complete a payment to the payee on or just before the payment due date without incurring a late penalty. The payee may provide an incentive for the consumer to make payments in this way because the transaction processor may credit the funds to the payee within one day or even on the same day in some examples. In return for processing the transaction, the transaction processor may charge a fee to the consumer, the payee, or both for the service.

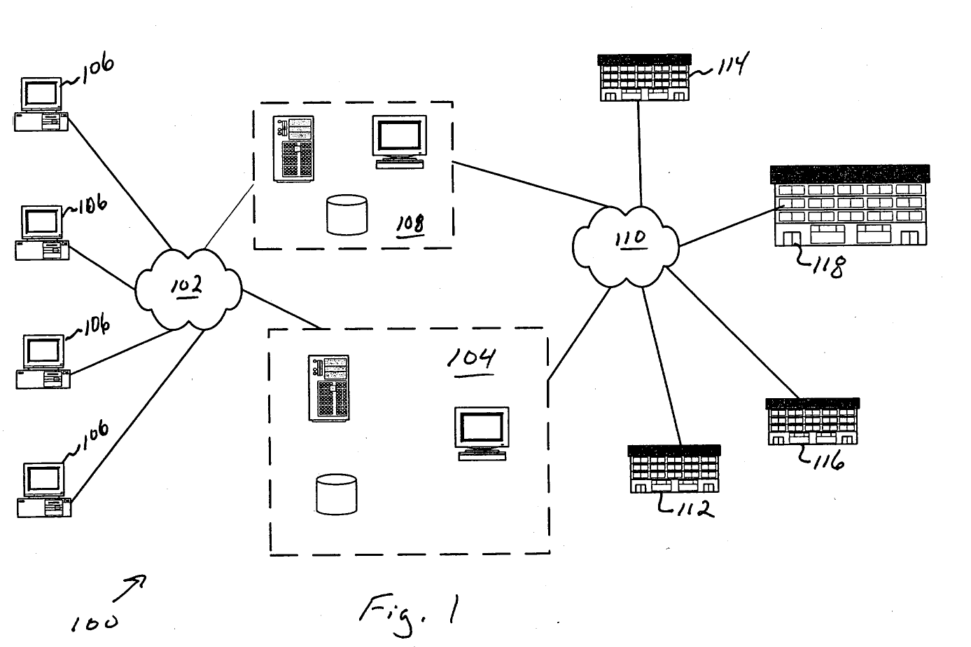

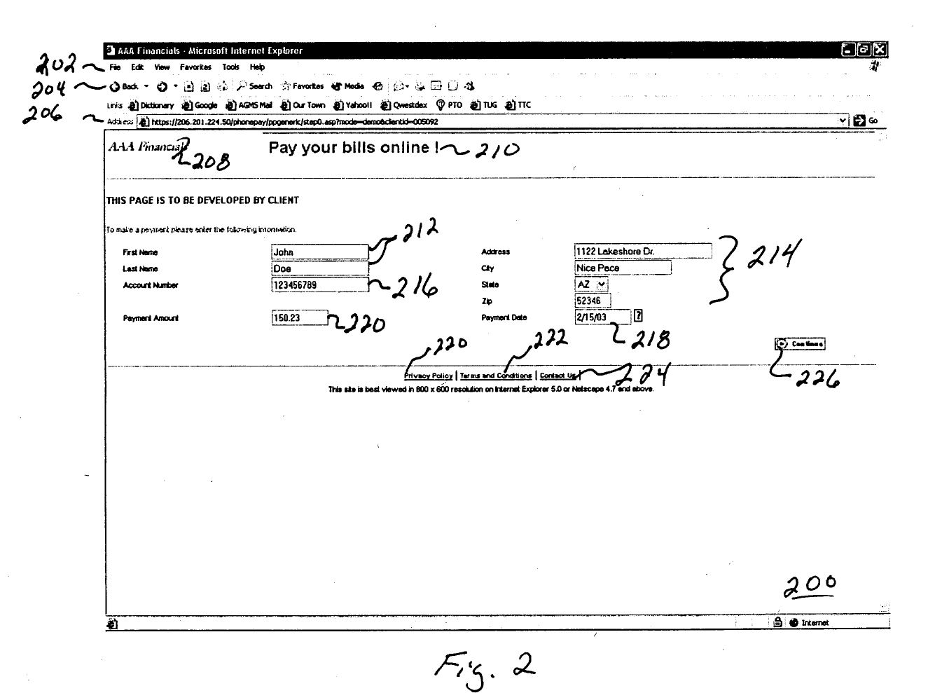

Having described the present invention generally, attention is directed to FIG. 1, which illustrates one exemplary embodiment of a payment processing system 100 according to the present invention. The present invention is not limited to the system 100. Those skilled in the art will recognize other possible embodiments of the present invention in light of the disclosure herein.

The system 100 includes a network 102 that enables communication among a host computer system 104, one or more consumer computing devices 106, and one or more payee computer systems 108. The network 102 may be any of a wide variety of networks, including optical or electrical networks, wired or wireless network, wide area or local area networks, virtual private networks, any combination of the foregoing, or the like. The host computer system 104, may be one or more of any of a wide variety of computing devices. For example, the host computer system may include mainframe processors, workstations, desktop computers, web servers, transaction processing computers, email servers, database servers, display devices, peripherals, and/or the like. The devices comprising the host computer system may be co-located in a single geographic area or distributed throughout a number of geographical areas. The host computer system 104 may be operated by or on behalf of a transaction processor. The consumer computing devices 106 may be any of a wide variety of computing devices, such as, desktop computers, laptop computers, workstations, personal digital assistants, and/or the like. The consumer computing devices may includes peripherals such as printers, display devices, modems, and/or the like. The payee computer systems 108 may include components similar to the host computer system 104, such as mainframe processors, workstations, desktop computers, web servers, accounting system processors, email servers, database servers, display devices, peripherals, and/or the like.

The system 100 also includes a banking network 110, which may be the same network as the network 102, or may be a different network. The banking network 110 enables the communication of banking transactions among the transaction processor's bank 112, a payee's bank 114, a consumer's bank 116, and a network operator 118. In a specific embodiment, the banking network 110 is the ACH network and the network operator 118 is the Federal Reserve.

The various computing devices of this example of the present invention may be programmed to perform the methods of the present invention. For example, the payee computer system 108 may be programmed to display web pages through an Internet browser at a consumer's computing device 106. Other examples of the programming of the computing devices of the present invention will become apparent in light of the disclosure herein.

The system 100 may be used to process payments between a consumer and a payee as previously described. Many consumers now use personal computers in the process of managing their financial affairs. Consumers receive advertisements and account information in the form of email from merchants and other businesses with whom they transact. Consumers also may use the Internet to access their account information and other information of interest from web sites representing the merchants and businesses. These emails and web pages may be generated at a computer system such as the payee computer system 108. In one example, a payee may send an email reminding a consumer that he has a payment due on an obligation the consumer incurred with the payee. In another example, the consumer may receive such a reminder upon accessing account information via the Internet. In either case, the payee may direct the consumer to a particular web page that will allow the consumer to make the payment.

The web page to which the payee directs the consumer may be hosted by a transaction processor at, for example, the host computer system 104. In a specific embodiment, the web page is designed such that the consumer appears to be interacting directly with the payee. For example, the web page may have the branding of the payee, and the URL (web site address) may be masked or otherwise altered to prevent alerting the consumer that he has left the computer system operated by the payee. It has been reported that such an arrangement is desired by payees, presumably because they have higher utilization rates from their consumers when consumers do not realize that another party is involved in the process. Thus, in an effort to provide a more desirable product to its clients, a financial services company interested in providing transaction processing services for its clients (payees) may design a system that receives payment information from consumers without alerting the consumers that the transaction processor is involved. Of course, many other examples are possible.

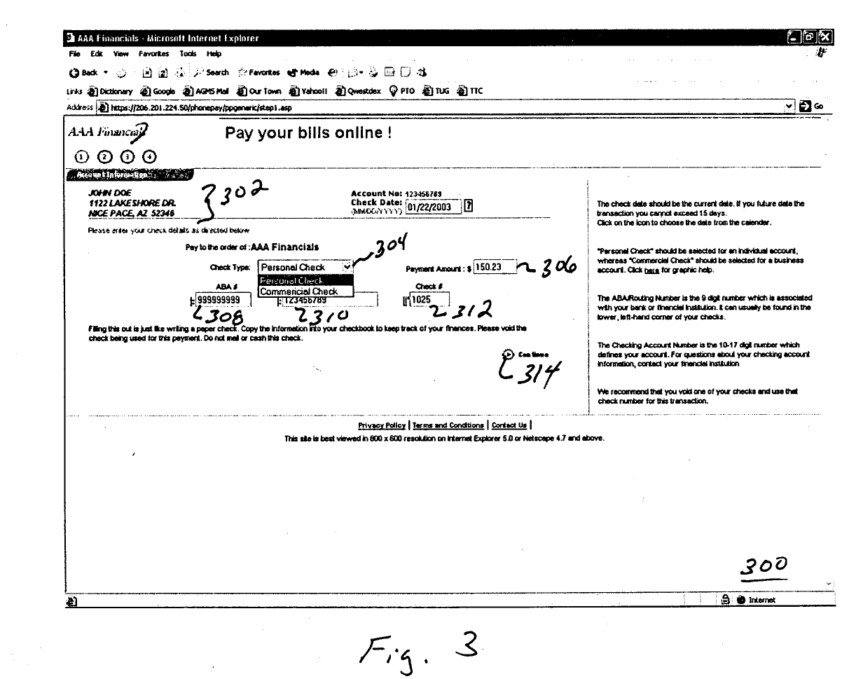

The payment web page may look like the example of a payment screen 200 pictured in FIG. 2. The payment screen 200 may be a web page displayed in a web browser, as is known in the art. The payment screen 200 may include a menu bar 202, navigation button bar 204, address bar 206, and other features common in web browser environments. With respect to the features of the present invention, the payment screen 200 may include a client logo 208 and a page title 210. The payment screen 200 also includes a number of data fields to be completed by the consumer to initiate payment, as will be explained.

The payment screen 200 includes data fields for the customer's name 212, address 214, account number 216, payment date 218, and payment amount 220. In some embodiments, the payment screen 200 may be pre-populated with information from the payee's records relating to the customer. For example, the consumer's account number with the payee may appear in the account number field 216. This information may be passed to the host computer system 104 by the payee computer system 108 at the time the consumer initiates the transaction. Alternatively, the payee periodically may pass an electronic file to the host computer system 104 that includes a “master list” of the payee's consumers. The host computer system 104 may consult this file to pre-populate information in the data fields of the display screens. The data fields may be fill-in-the-blank fields, or may include selection features such as drop-down menus. Many other examples are possible.

In some embodiments, the consumer may be able to future-date a payment. If the consumer wants a payment to be processed in the future, the consumer may enter a date in the payment date field 218 that is in the future. The system may, however, place a limit on how far in the future a consumer may date a payment.

The payment screen 200 also may include hyperlinks for information such as a privacy policy 220, terms and conditions 222, and contact information 224 for the payee or the transaction processor. A continue button 226 takes the customer to the next display screen in the sequence.

In some embodiments, security features may prevent unauthorized access by others than the consumer to a payment screen relating to a particular consumer. For example, the payment screen 200 may be accessed by the consumer by linking directly from an account information screen (not shown) that required the consumer to enter an account number, a user ID, a password, and/or the like. In other embodiments, the payment screen may be immediately preceded by a verification screen. The security features may be housed at either the payee computer system 108 or the host computer system 104 or elsewhere. Many other examples are possible.

FIG. 3 illustrates an example of a bank information screen 300 that the consumer may encounter by selecting the continue button 226 of FIG. 2. The bank information screen may include consumer information 302 entered in the payment screen 200 of FIG. 2. The bank information screen also may include instructions for entering bank information. The bank information screen includes data fields for the type of check the consumer is using (e.g., either business or personal) 304, the payment amount 306 (which may be corrected if entered incorrectly in the previous screen), the consumer's bank's ABA # 308, the consumer's bank account # 310, and the check # 312. Again, drop-down menus may facilitate entering information into the data fields. It is also possible that some of the information in the banking information screen 300 may be pre-populated, if, for example, the consumer previously paid the payee in a similar manner. A continue button 314 takes the consumer to the next display screen in the sequence.

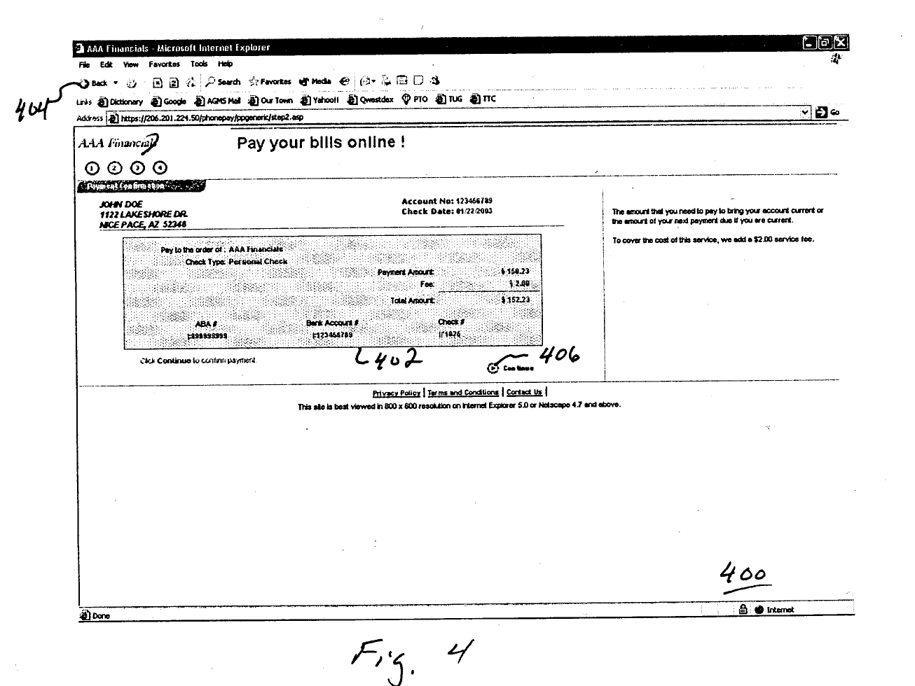

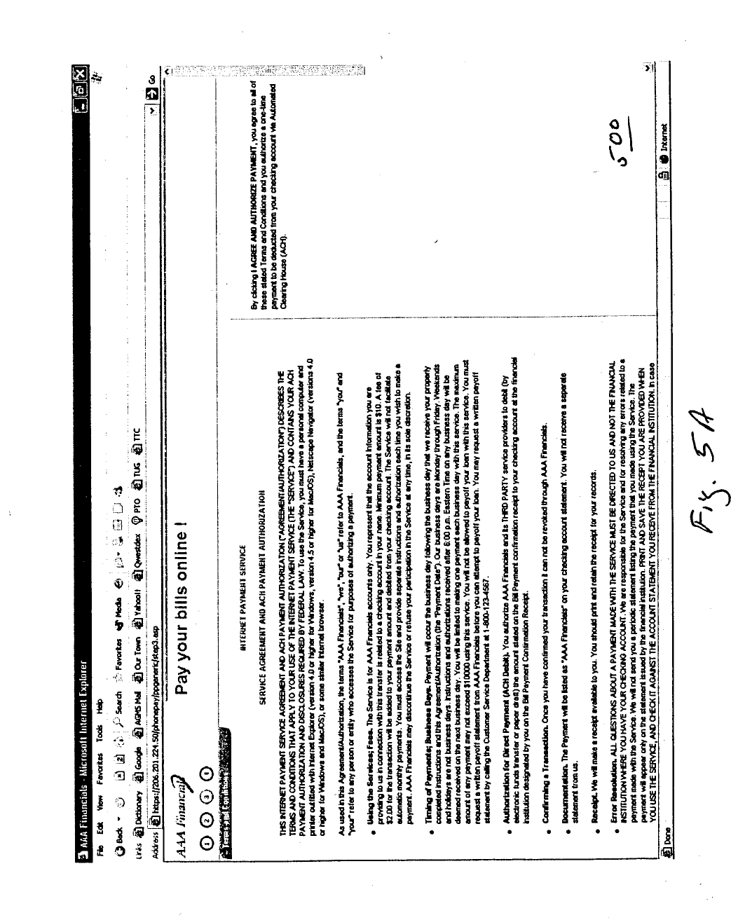

FIG. 4 illustrates a payment confirmation screen 400 according to the present invention. The payment confirmation screen 400 includes information previously entered by the consumer summarized in the form of a check 402 similar to one the consumer may have prepared had the consumer paid the debt using a traditional paper check. If any of the information is incorrect, the consumer may select the back button 404 to return to a previous screen in the sequence. If the information is all correct and the consumer wishes to proceed, the continue button 406 takes the consumer to the next display screen in the sequence.

The payment confirmation screen 400 also may display any taxes or fees that may be charged to the consumer in addition to the payment. The host computer system 104 may calculate the taxes and/or fees by consulting information is a database. The taxes and/or fees may be state-specific and/or payee specific. The information in the database may be updated periodically to integrate changes.

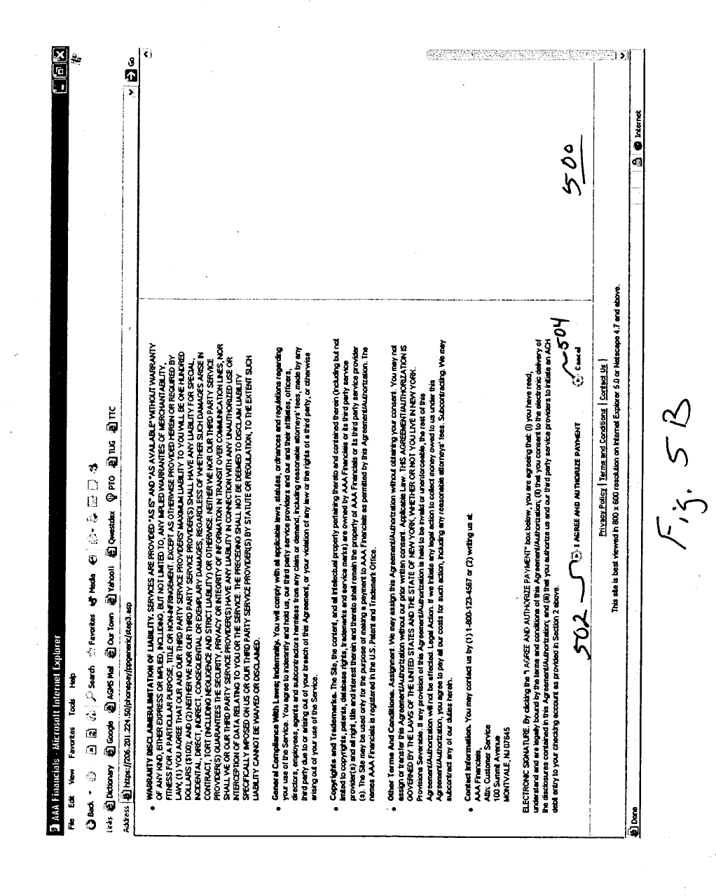

FIGS. 5A and B illustrate top and bottom portions, respectively, of a terms and conditions screen 500. The terms and conditions screen 500 provides the consumer with important information regarding his payment. In some embodiments, the consumer may be required to scroll to the bottom of the screen in order to reveal an accept button 502, which must be selected to complete the transaction. A cancel button 504 may allow the consumer to abort the payment.

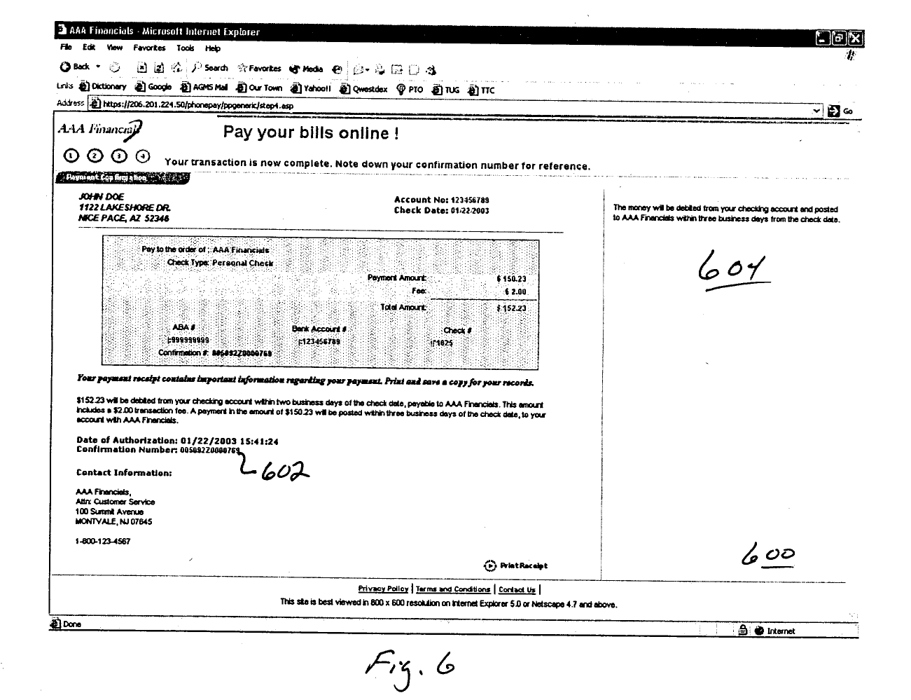

If the consumer accepts the terms and conditions by selecting the accept button 502, the final confirmation screen 600 of FIG. 6 is displayed. The final confirmation screen 600 includes the relevant information relating to the payment provided by the consumer, as well as, a confirmation number 602. Information relating to the processing of the payment also may be provided in an information area 604.

The preceding display screens of FIGS. 2-6 illustrate but one exemplary embodiment of a sequence of display screen that may be used to obtain payment information from a consumer for a payment to a payee. Many other examples are possible.

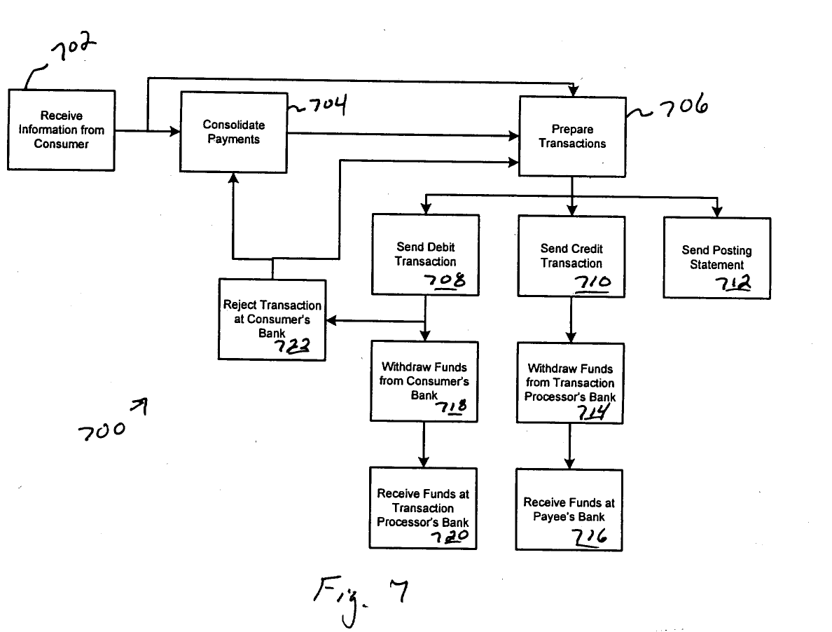

The information from a number of different payments from consumers may be collected at the host computer system 104 of FIG. 1 and periodically consolidated into a batch before being processed according to the method to be described hereinafter. In other embodiments, each payment may be processed as it is received. A method of processing a payment according to the present invention is described with respect to FIG. 7.

FIG. 7 is a flow diagram illustrating one embodiment of a method 700 of processing a payment from a consumer to a payee according to embodiments of the present invention. The method 700 begins at block 702 wherein information for the payment is collected from a consumer. As previously described, the information may be collected via a web site operated by a transaction processor on behalf of a payee and made to look like it is operated by the payee. The web site may include security features that limit access, as previously described. Optionally, at block 704, information from a number of different payments is consolidated into a batch.

At block 706, the information supplied by the consumer is used to generate one or more transactions. For example, a debit transaction may be prepared to withdraw funds from a consumer's bank, and a credit transaction may be prepared to deposit funds into a payee's bank. Although a single transaction could accomplish the transfer of funds from a consumer bank to a payee bank, the movement of funds through a banking network may not result in the payee being credited with receipt of funds for several days. Thus, a transaction processor, according to the present invention, transfers funds from its bank to the payee in the credit transaction and transfers funds from the consumer's bank to its bank in the debit transaction.

Also at block 706, a posting statement is prepared for the payee. The posting statement provides the payee with information relating to one or more payments. The posting statement may be sent to the payee via an email, or, in some embodiments, may result in entries directly into the payee's accounting system.

Block 706 also may include the consolidation of new payments with reverse payments that were, for one reason or another, returned from a consumer's bank. This may happen, for example, if a consumer stops a payment or has insufficient funds in his account to cover the payment.

At block 708, the debit transaction is processed through a banking network, such as the ACH network. At block 710, the credit transaction is processed through the banking network. At block 712, the posting statement is sent to the payee's computer system. The actions at blocks 708, 710, and 712 may take place simultaneously or within a relatively short time from one another. For example, the credit transaction may be sent during the same banking day as the debit transaction or within one day after.

The processing of transactions through the banking network may be regulated by particular rules. For example, it may be the case that the transaction processor must introduce the transactions through a qualified party, such as an Original Depository Financial Institution (ODFI). It may also be the case that the transactions must be sent to an operator of the network, such as the Federal Reserve. The network operator serves as a clearing house for transactions within the network. Other financial networks operate by different rules, and the present invention may be adapted accordingly.

At block 714, funds are withdrawn from the transaction processor's account. At block 716, funds are deposited into the payee's account. At block 718, funds are withdrawn from the consumer's account. At block 720, funds are deposited into the transaction processor's account. In some embodiments, the funds are deposited in the payee's bank at operation 716 within one banking day of the day that the customer initiates the payment at block 702. In some embodiments, the funds are not deposited into the transaction processor's account at operation 720 until at least one banking day after funds are withdrawn from the transaction processor's account at operation 714. Thus, the transaction processor may be “at risk” for the period of time between the withdrawal of funds from its account until funds are received from the consumer's bank.

As previously mentioned, the consumer's bank may return the debit transaction unprocessed. If this happens, the information is received at block 722, and the information is used in the preparation of transactions at block 706. Alternatively, the information is used at block 704 to consolidate multiple transactions.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to processing payments through a banking network. Other networks, such as credit card networks, may be used as well. Accordingly, the above description should not be taken as limiting the scope of the invention, which is defined in the following claims.

What is claimed is:

1. A method of processing a payment from a payer to a payee, comprising:
receiving at a host computer system a request to initiate a payment;
transmitting from the host computer system to a payer computer a file comprising a display screen configured for receiving, from the payer, information relating to the payment;
receiving the information from the payer at the host computer system;
creating with the host computer system a credit transaction based on the information that debits funds from a transaction processor's bank and credits funds to a bank of the payee;
creating with the host computer system a debit transaction based on the information that debits funds from a bank of the payer and credits funds to the transaction processor's bank; and
sending both the debit transaction and the credit transaction to a banking network within one banking day.

2. The method of claim 1, wherein the banking network comprises the Automated Clearing House (ACH) network.

3. The method of claim 1, further comprising receiving funds at the payee's bank within one banking day of receiving the information from the payer.

4. The method of claim 1, further comprising:
creating with the host computer system a posting statement based on the information; and
sending the posting statement to a payee computing system.

5. The method of claim 1, further comprising:
calculating a fee relating to the payment; and
transmitting a file to the payer computer, wherein the file comprises a display screen that displays the fee to the payer.

6. The method of claim 1, further comprising:
receiving a request from the payer to abort the transaction; and
aborting the transaction.

7. The method of claim 1, further comprising:
receiving a notification that the bank of the payer has rejected the transaction;
creating a reversal transaction that withdraws funds from the bank of the payee; and
sending the debit transaction to the banking network.

8. The method of claim 7, further comprising:
receiving information from other payers similar to the information from the payer; and
using the notification and the similar information to prepare a debit transaction and a credit transaction.

9. The method of claim 1, further comprising:
consolidating the information from the payer with similar information from other payers; and
using the consolidated information to prepare a debit transaction and a credit transaction.

10. A payee computer system, comprising:
means for interacting, via a network, with a payer;
means for receiving from the payer a request to make a payment to the payee;
means for linking the payer to a transaction processor's computer system that is programmed to present a series of payment information receiving screens having branding information relating to the payee.

11. The system of claim 10, further comprising:
means for transferring information relating to the payer to the transaction processor's computer system.

12. A method of receiving payment information from a payer, comprising:
interacting, via a network, with the payer;
receiving from the payer a request to make a payment to the payee; and
linking the payer to a transaction processor's computer system that is programmed to present a series of payment information receiving screens having branding information relating to the payee.

13. A system for processing a payment from a payer to a payee, comprising:
a host computer system, comprising:
an interface to a payer computer;
an interface to a banking network; and
an interface to a payee computing system;
wherein the host computer system is programmed to:
receive through the interface to the payer computer a request from the payer to initiate a payment;
transmit from the host computer system to the payer computer through the interface to the payer computer a file comprising a display screen configured for receiving information relating to the payment from the payer;
receive the information from the payer computer through the interface to the payer computer;
create a credit transaction that debits funds from a transaction processor's bank and credits funds to a bank of the payee;
create a debit transaction based on the information that debits funds from a bank of the payer and credits funds to the transaction processor's bank; and
send both the debit transaction and the credit transaction to the banking network through the interface to the banking network on a banking day.

14. The system of claim 13, wherein the banking network comprises the Automated Clearing House (ACH) network.

15. The system of claim 13, wherein the host computer system is further programmed to send the credit transaction to the banking network such that the funds are received at the payee's bank within one banking day of the day the host computer system receives the information from the payer.

16. The system of claim 13, wherein the host computer system is further programmed to:
create a posting statement based on the information; and
send the posting statement to the payee computing system through the interface to the payee computing system.

17. The system of claim 13, wherein the host computer system is further programmed to:
calculate a fee relating to the payment; and
transmit a file to the payer computer through the interface to the payer computer, wherein the file comprises a display screen that displays the fee to the payer.

18. The system of claim 13, wherein the host computer system is further programmed to:
receive a request from the payer to abort the transaction; and
abort the transaction.

19. The system of claim 13, wherein the host computer system is further programmed to:
receive a notification that the bank of the payer has rejected the transaction;
create a reversal transaction that withdraws funds from the bank of the payee; and
send the debit transaction to the banking network.

20. The system of claim 19, wherein the host computer system is further programmed to:
receive information from other payers similar to the information from the payer; and
use the notification and the similar information to prepare a debit transaction and a credit transaction.

21. The system of claim 13, wherein the host computer system is further programmed to:
consolidate the information from the payer with similar information from other payers; and
use the consolidated information to prepare a debit transaction and a credit transaction.
